(19) United States
(12) Patent Application Publication
(10) Pub. No.: US 2026/0193395 A1
(43) Pub. Date: Jul. 9, 2026

(54) METHOD FOR PRODUCING PARTICLES CONTAINING FLUORINATED POLYMER

(71) Applicant: AGC INC., Tokyo (JP)

(72) Inventors: Satoshi MATSUSHITA, Tokyo (JP); Susumu SAITO, Tokyo (JP)

(73) Assignee: AGC INC., Tokyo (JP)

(21) Appl. No.: 19/553,603

(22) Filed: Mar. 2, 2026

Related U.S. Application Data
(63) Continuation of application No. PCT/JP2024/030617, filed on Aug. 28, 2024.

(30) Foreign Application Priority Data
Sep. 5, 2023 (JP) 2023-143764

(51) Int. Cl. C08F 216/14; B01J 39/05; B01J 39/19

(52) U.S. Cl. CPC C08F 216/1475; B01J 39/05; B01J 39/19

(57) ABSTRACT

To provide a method for producing particles containing a fluorinated polymer, by which particles containing a fluorinated polymer with a low content of impurities, can be produced. The method for producing particles containing a fluorinated polymer of the present invention is a method for producing particles containing a fluorinated polymer having groups convertible to ion exchange groups, which comprises preparing a liquid composition containing the fluorinated polymer and a first solvent, and mixing the liquid composition with a second solvent that is an olefin having a fluorine atom and a chlorine atom, to agglomerate the fluorinated polymer thereby to form particles containing the fluorinated polymer.

### TECHNICAL FIELD

The present invention relates to a method for producing particles containing a fluorinated polymer.

### BACKGROUND ART

Ion exchange membranes (electrolyte membranes) of polymer electrolyte fuel cells and water hydrolyzers are obtained by forming a fluorinated polymer having ion exchange groups such as sulfonic acid groups into a membrane.

The fluorinated polymer having ion exchange groups such as sulfonic acid groups is obtained by hydrolyzing, in a fluorinated polymer having fluorosulfonyl groups as groups convertible to ion exchange groups, the fluorosulfonyl groups and converting them into acid form.

As a method for producing such a fluorinated polymer having groups convertible to ion exchange groups, Patent Document 1 in Ex. 1 discloses a method of adding an organic solvent (HCF₂CF₂OCH₂CF₃) into a polymer solution obtained by copolymerizing tetrafluoroethylene and a monomer represented by CF₂═CFOCF₂CF(CF₃) OCF₂CF₂SO₂F in the presence of an organic solvent (CF₃CF₂CF₂CF₂CF₂CF₂H) to agglomerate the fluorinated polymer thereby to obtain particles containing the fluorinated polymer.

### PRIOR ART DOCUMENTS

### Patent Documents

Patent Document 1: Japanese Patent No. 6642452

### DISCLOSURE OF INVENTION

### Technical Problem

The particles containing the fluorinated polymer having groups convertible to ion exchange groups may sometimes include impurities such as unreacted monomers. If the particles containing the fluorinated polymer include impurities in a large amount, an ion exchange membrane produced by using the particles tends to have performance deteriorated.

The present inventors have produced particles containing a fluorinated polymer having groups convertible to ion exchange groups, in accordance with the method described in Patent Document 1, Ex. 1, and as a result found that the content of impurities in the particles can still be reduced.

The present invention has been made to solve the above problems and its object is to provide a method for producing particles containing a fluorinated polymer, by which particles containing a fluorinated polymer with a low content of impurities can be produced.

### Solution to Problem

The present inventors have conducted extensive studies to achieve the above object and as a result found the following. That is, a liquid composition containing a fluorinated polymer and a first solvent is prepared, and the liquid composition and a second solvent that is an olefin having a fluorine atom and a chlorine atom, are mixed to agglomerate the fluorinated polymer. Then, in the resulting particles containing the fluorinated polymer, the content of impurities is reduced. The present invention has been accomplished on the basis of this discovery.

That is, the present inventors have found that the above object can be accomplished by the following configurations.

[1]

A method for producing particles containing a fluorinated polymer having groups convertible to ion exchange groups,
which comprises preparing a liquid composition containing the fluorinated polymer and a first solvent, and
mixing the liquid composition with a second solvent that is an olefin having a fluorine atom and a chlorine atom, to agglomerate the fluorinated polymer thereby to form particles containing the fluorinated polymer.
   [2]

The method for producing particles containing a fluorinated polymer according to [1], wherein the olefin has three carbon atoms.

[3]

The method for producing particles containing a fluorinated polymer according to [1] or [2], wherein the olefin has a normal boiling point of 14 to 89° C.

[4]

The method for producing particles containing a fluorinated polymer according to any one of [1] to [3], wherein the fluorinated polymer has units based on tetrafluoroethylene and units based on a compound represented by the formula (1):

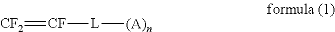

in the formula (1), L is a (n+1)-valent perfluorohydrocarbon group which may have an etheric oxygen atom, A is a group convertible to a sulfonic acid functional group, and nis 1 or 2.
   [5]

The method for producing particles containing a fluorinated polymer according to [4], wherein the first solvent contains at least one member selected from the group consisting of the compound represented by the formula (1) and an organic solvent.

[6]

The method for producing particles containing a fluorinated polymer according to any one of [1] to [5], wherein the mass ratio of the content of the fluorinated polymer to the content of the first solvent in the liquid composition is 0.050 to 0.43.

[7]

The method for producing particles containing a fluorinated polymer according to any one of [1] to [6], wherein when the liquid composition and the second solvent are mixed, the mass ratio of the mass of the second solvent to the mass of the first solvent in the liquid composition is 1.0 to 8.0.

[8]

The method for producing particles containing a fluorinated polymer according to any one of [1] to [7], wherein the content of the first solvent is 70 mass % or more and 95 mass % or less to the total mass of the liquid composition.

[9]

The method for producing particles containing a fluorinated polymer according to any one of [1] to [8], wherein the particles have an average particle size of 38 μm or more and 10000 μm or less.

The method for producing particles containing a fluorinated polymer according to any one of [1] to [9], wherein the mixing is conducted by using the liquid composition having a temperature of 20° C. or higher and 60° C. or lower, and the second solvent having a temperature of −15° C. or higher and 30° C. or lower.

### Advantageous Effects of Invention

According to the present invention, it is possible to provide a method for producing particles containing a fluorinated polymer, by which particles containing a fluorinated polymer with a low content of impurities can be produced.

### DESCRIPTION OF EMBODIMENTS

The following definitions of terms apply throughout the present specification and claims unless otherwise specified.

An “ion exchange group” refers to a group containing at least one ion exchangeable for a different ion, such as a sulfonic acid functional group and a carboxylic acid functional group as described below.

A “sulfonic acid functional group” refers to a sulfonic acid group (—SO₃H) or a sulfonate group. The sulfonate group may be, for example, (—SO₃⁻)Ma⁺, (—SO₃⁻)₂Mb²⁺ or (—SO₃⁻)₃Mc³⁺ (where Ma⁺ is an alkali metal ion or a quaternary ammonium cation; Mb²⁺ is a divalent metal ion; Mc³⁺ is a trivalent metal ion). When there are two ligands, the number of ion exchange groups is counted as 2, and when there are three ligands, the number of ion exchange groups is counted as 3.

A “carboxylic acid functional group” refers to a carboxylic acid group (—COOH) or a carboxylate group. The carboxylate group may be, for example, (—COO⁻)Ma⁺, (—COO⁻)₂Mb²⁺ or (—COO⁻)₃Mc³⁺ (where Ma⁺ is an alkali metal ion or a quaternary ammonium cation; Mb²⁺ is a divalent metal ion; and Mc³⁺ is a trivalent metal ion). When there are two ligands, the number of ion exchange groups is counted as 2, and when there are three ligands, the number of ion exchange groups is counted as 3.

A “group convertible to an ion exchange group” refers to a group that can be converted to an ion exchange group by treatments such as hydrolysis and conversion to acid form.

A “group convertible to a sulfonic acid functional group” refers to a group that can be converted to a sulfonic acid functional group by treatments such as hydrolysis and conversion to acid form.

A “group convertible to a carboxylic acid functional group” refers to a group that can be converted to a carboxylic acid functional group by treatments such as hydrolysis and conversion to acid form.

A “unit” in a polymer refers to an atomic group derived from a single monomer molecule, which is formed by polymerization reaction of the monomer. A unit may be an atomic group formed directly by polymerization or may be an atomic group formed by polymerization followed by modification to a partially different structure. In the following, in some cases, units derived from a certain monomer will be represented by the monomer name, followed by “units”.

A numerical range expressed using “to” means a range including numerical values described before and after “to” as the lower and upper limits. In a series of numerical ranges described in the present specification, the upper limit or lower limit of a numerical range may be replaced by the upper limit or lower limit of another numerical range in the same series. The upper limit or lower limit of any numerical range described in the present specification may be replaced by any of numerical values indicated in Examples.

### [Method for Producing Particles Containing Fluorinated Polymer]

The method for producing the fluorinated polymer of the present invention is a method for producing particles containing a fluorinated polymer having groups convertible to ion exchange groups (hereinafter sometimes referred to as “polymer F”),
which comprises preparing a liquid composition containing the fluorinated polymer F and a first solvent, and
mixing the liquid composition with a second solvent that is an olefin having a fluorine atom and a chlorine atom, to agglomerate the polymer F thereby to form particles containing the polymer F.

According to the present production method, particles containing the fluorinated polymer with a low content of impurities can be produced. The detailed reasons are not clearly understood yet but are considered to be as follows. It is considered that use of the second solvent for agglomeration of the polymer F suppresses inclusion of components other than the polymer F, (for example, monomers used for production of the polymer F, oligomers formed at the time of production of the polymer F, solvents and the like) into the particles.

Further, by use of the second solvent for agglomeration of the polymer F, components other than the polymer F in the particles are likely to be removed, by subjecting the agglomerated polymer F to treatment such as washing or drying.

### <Liquid Composition>

The liquid composition contains the polymer F and the first solvent. The liquid composition may be a solution having the polymer F dissolved in the first solvent, or may be a dispersion having the polymer F dispersed in the first solvent.

The turbidity of the liquid composition is preferably 500 NTU or less. The liquid composition having such a turbidity can be considered to be a solution having the polymer F dissolved in the first solvent or a dispersion having the polymer F dispersed in the first solvent.

The turbidity of the liquid composition may be measured by using a turbidimeter employing scattered light measurement system, with respect to the liquid composition immediately after obtained in the after-described step 1. Specifically, 90° scattered light measured (measurement wavelength: 850 nm) at room temperature, using a portable turbidimeter TN-100 manufactured by EUTECH INSTRUMENTS, was taken as the turbidity. As the sample to be measured, 10 mL of the sample is put in a borosilicate glass vial (diameter 25 mm, height 51 mm) and subjected to measurement. The calibration curve can be prepared by using a calibration solution containing EPA-compliant polymer-based reference material (0.02 NTU, 20.0 NTU, 100 NTU, 800 NTU).

### <Polymer F>

The polymer F is not particularly limited so long as it is a polymer having fluorine atoms and the groups convertible to ion exchange groups, and preferred are the following polymer F-1 and polymer F-2 in that more excellent effects of the present invention will be achieved.

### (Polymer F-1)

The polymer F-1 is a copolymer having unis based on a fluorinated olein and units based on a fluorinated monomer having a group convertible to an ion exchange group, preferably a copolymer having units based on a fluorinated olefin (preferably tetrafluoroethylene) and units based on a fluorinated monomer having a group convertible to a sulfonic acid functional group (preferably a compound represented by the formula (1) described later).

The polymer F-1 preferably has no cyclic ether structure.

The fluorinated olefin may be, for example, a C₂₋₃ fluoroolefin having at least one fluorine atom in the molecule. Specific examples of the fluoroolefin include tetrafluoroethylene (hereinafter also referred to as “TFE”), chlorotrifluoroethylene, vinylidene fluoride, vinyl fluoride and hexafluoropropylene. Among them, TFE is preferred in terms of the monomer production cost, the reactivity with other monomers and the ability to give the polymer F-1 with excellent properties.

The fluorinated olefin may be used alone or as a combination of two or more.

The content of the units based on a fluorinated olefin is, to all units in the polymer F-1, preferably 11 mass % or more, more preferably 38 mass % or more, and preferably 59 mass % or less, more preferably 55 mass % or less.

The fluorinated monomer having a group convertible to an ion exchange group may be a compound having one or more fluorine atoms, having an ethylenic double bond and having a group convertible to a sulfonic acid functional group.

The fluorinated monomer having a group convertible to an ion exchange group is, in terms of the monomer production cost, the reactivity with other monomers and the ability to give the polymer F-1 with excellent properties, preferably the compound represented by the formula (1):

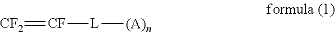

Here, L is a (n+1)-valent perfluorohydrocarbon group which may contain an etheric oxygen atom.

The etheric oxygen atom may be located at a terminal end or may be located between carbon atoms of the perfluorohydrocarbon group.

The number of carbon atoms in the (n+1)-valent perfluorohydrocarbon group is preferably 1 or more, more preferably 2 or more, and is preferably 20 or less, more preferably 10 or less.

As L, preferred is a (n+1)-valent perfluoroaliphatic hydrocarbon group which may contain an etheric oxygen atom. More preferred is a divalent perfluoroalkylene group which may contain an etheric atom oxygen atom as corresponding to an embodiment of n=1, or a trivalent perfluoroaliphatic hydrocarbon group which may contain an etheric oxygen atom as corresponding to an embodiment of n=2.

The above-mentioned divalent perfluoroalkylene group may be linear or branched.

A is a group convertible to a sulfonic acid functional group. The group convertible to a sulfonic acid functional group is preferably a functional group convertible to a sulfonic acid functional group by hydrolysis. Specific examples of the group convertible to a sulfonic acid functional group include —SO₂F, —SO₂Cl, and —SO₂Br.

n is 1 or 2.

The compound represented by the formula (1) is preferably a compound represented by the formula (1-1), a compound represented by the formula (1-2), a compound represented by the formula (1-3) or a compound represented by the formula (1-4).

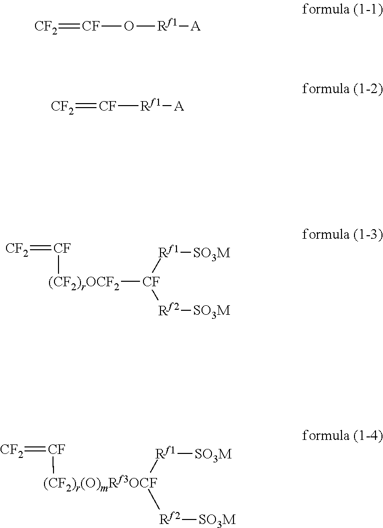

R^{f1} is a perfluoroalkylene group which may have an oxygen atom between carbon atoms. The number of carbon atoms in the perfluoroalkylene group is preferably 1 or more, more preferably 2 or more, and is preferably 20 or less, more preferably 10 or less.

R^{f2} is a single bond or a perfluoroalkylene group which may have an oxygen atom between carbon atoms. The number carbon atoms in the perfluoroalkylene group is preferably 1 or more, more preferably 2 or more, and is preferably 20 or less, more preferably 10 or less.

R^{f3} is a single bond or a perfluoroalkylene group which may have an oxygen atom between carbon atoms. The number carbon atoms in the perfluoroalkylene group is preferably 1 or more, more preferably 2 or more, and is preferably 20 or less, more preferably 10 or less.

r is 0 or 1.

m is 0 or 1.

The definition of A in the formulae is as defined above.

The compound represented by the formula (1-1) and the compound represented by the formula (1-2) are preferably a compound represented by the formula (1-5).

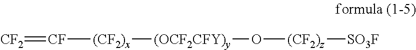

x is 0 or 1, y is an integer of 0 to 2, z is an integer of 1 to 4, and Y is F or CF₃.

Specific examples of the compound represented by the formula (1-1) include the following compounds. In the formulae, w is an integer of 1 to 8, and x is an integer of 1 to 5.

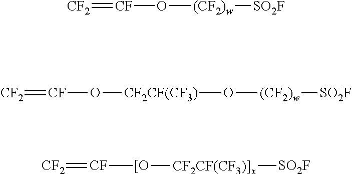

Specific examples of the compound represented by the formula (1-2) include the following compounds. In the formulae, w is an integer of 1 to 8.

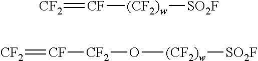

As the compound represented by the formula (1-3), a compound represented by the formula (1-3-1) is preferred.

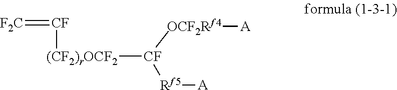

R^{f4} is a C₁₋₆ linear perfluoroalkylene group, and R^{f5} is a single bond or a C₁₋₆ linear perfluoroalkylene group which may contain an oxygen atom between carbon atoms.
r and A are as defined above.

Specific examples of the compound represented by the formula (1-3-1) are as follows.

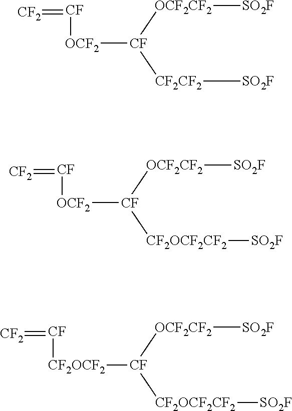

The compound represented by the formula (1-4) is preferably a compound represented by the formula (1-4-1).

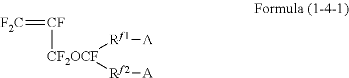

In the formula, R^{f1}, R^{f2} and A are as defined above.

Specific examples of the compound represented by the formula (1-4-1) are as follow.

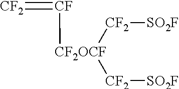

The fluorinated monomer having a group convertible to an ion exchange group may be used alone or as a combination of two or more.

The content of the units based on the fluorinated monomer having a group convertible to an ion exchange group is, to all units in the polymer F-1, preferably 41 mass % or more, more preferably 45 mass % or more, and preferably 89 mass % or less, more preferably 62 mass % or less.

For production of the polymer F-1, a monomer other than the above monomer (hereinafter sometimes referred to as “other monomer”) may be used.

Specific examples of other monomer include CF₂═CFR^{f6} (wherein R^{f6} is a C₂₋₁₀ perfluoroalkyl group), CF₂═CF—OR^{f7} (wherein R^{f7} is a C₁₋₁₀ perfluoroalkyl group), and CF₂═CFO(CF₂)ᵥCF═CF₂ (wherein v is an integer of 1 to 3).

The content of units based on the other monomer is preferably 30 mass % or less to all units in the polymer F-1 with a view to maintaining the ion exchange capacity.

### (Polymer F-2)

The polymer F-2 is a fluorinated polymer having units based on a monomer having a cyclic ether structure and having ion exchange groups, and is preferably a copolymer having units based on a monomer having a cyclic ether structure and units based on a fluorinated monomer having a group convertible to an ion exchange group.

Specific examples of the monomer having a cyclic ether structure include monomer m11, monomer m12, monomer m21 and monomer m22.

The monomer m11 is a monomer represented by the formula (m11), and as preferred embodiments of the monomer m11, the formulae (m11-1) to (m11-4) may be mentioned.

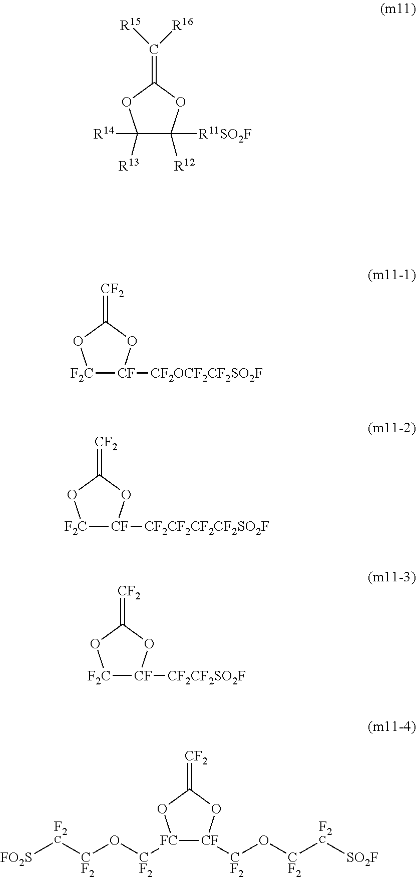

R¹¹ is a bivalent perfluoroalkylene group which may have an etheric oxygen atom. When the perfluoroalkylene group has an etheric oxygen atom, the number of the oxygen atom may be one or more. The oxygen atom may be located in a carbon-carbon bond or at a terminal end of the carbon atom bond of the perfluoroalkylene group. The perfluoroalkylene group may be linear or branched and is preferably linear.

R¹², R¹³, R¹⁵ and R¹⁶ are each independently a monovalent perfluoroalkyl group which may have an etheric oxygen atom, or a fluorine atom. It is preferred that at least one of R¹⁵ and R¹⁶ is a fluorine atom, in view of high polymerizability, and it is more preferred that both of them are fluorine atoms.

R¹⁴ is a monovalent perfluoroalkyl group which may have an etheric oxygen atom, a fluorine atom or a group represented by —R¹¹SO₂F. When the perfluoroalkyl group has an etheric oxygen atom, the number of the oxygen atom may be one or more. The oxygen atom may be located in a carbon-carbon bond or at a terminal end of the carbon atom bond of the perfluoroalkylene group. The perfluoroalkyl group may be linear or branched and is preferably linear. When the formula (m11) has two R¹¹, the two R¹¹ may be the same or different from each other.

The monomer m12 is a monomer represented by the formula (m12), and as preferred embodiments of the monomer m12, the formulae (m12-1) to (m12-2) may be mentioned.

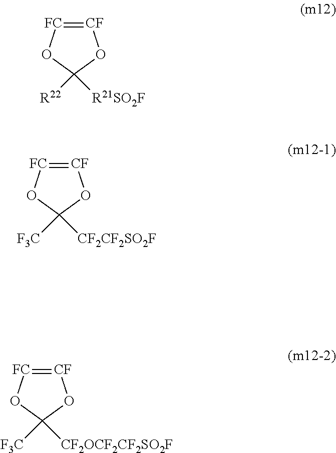

R²¹ is a C₁₋₆ perfluoroalkylene group or a C₂₋₆ perfluoroalkylene group having an etheric oxygen atom in a carbon-carbon bond. When the perfluoroalkylene group has an etheric oxygen atom, the number of the oxygen atom may be one or more. The perfluoroalkylene group may be linear or branched and is preferably linear.

R²² is a fluorine atom, a C₁₋₆ perfluoroalkyl group, a C₂₋₆ perfluoroalkyl group having an etheric oxygen atom in a carbon-carbon bond or a group represented by —R²¹SO₂F. When the perfluoroalkyl group has an etheric oxygen atom, the number of the oxygen atom may be one or more. The perfluoroalkyl group may be linear or branched and is preferably linear. When the formula (m12) has two R²¹, the two R²¹ may be the same or different from each other.

The monomer m21 is a monomer represented by the formula (m21), and as preferred embodiments of the monomer m21, the formulae (m21-1) to (m21-2) may be mentioned.

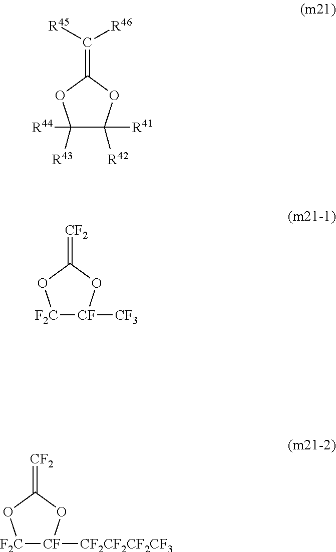

R⁴¹, R⁴², R⁴³, R⁴⁴, R⁴⁵ and R⁴⁶ are each independently a monovalent perfluoroalkyl group which may have an etheric oxygen atom, or a fluorine atom. When the perfluoroalkyl group has an etheric oxygen atom, the number of the oxygen atom may be one or more. The oxygen atom may be located in a carbon-carbon bond or may be located at a terminal end of a carbon atom bond in the perfluoroalkyl group. The perfluoroalkyl group may be linear or branched and is preferably linear.

It is preferred that at least one of R⁴⁵ and R⁴⁶ is a fluorine atom, in view of high polymerizability, and it is more preferred that both of them are fluorine atoms.

The monomer m22 is a monomer represented by the formula (m22), and as preferred embodiments of the monomer m22, the formulae (m22-1) to (m22-11) may be mentioned.

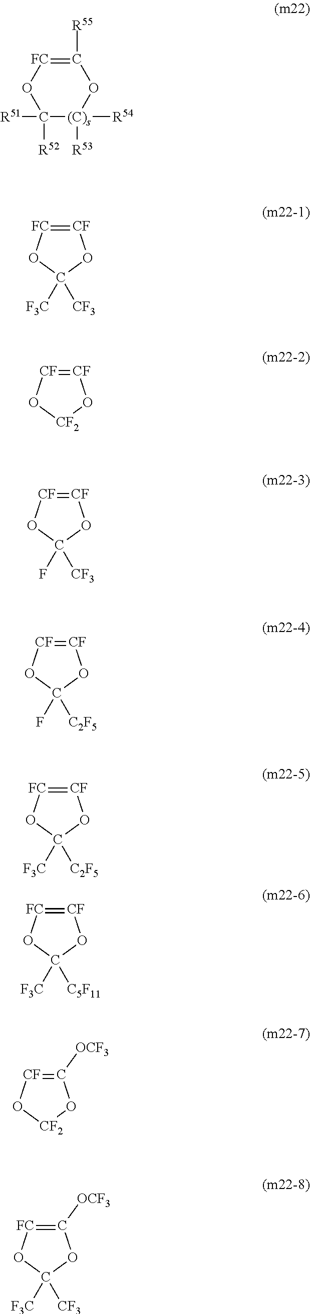

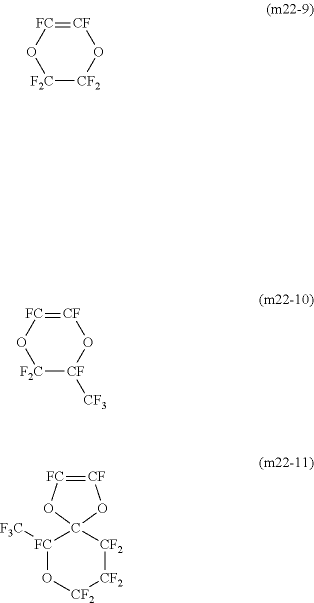

s is 0 or 1 and is preferably 0.

R⁵¹ and R⁵² are each independently a fluorine atom or a C₁₋₅ perfluoroalkyl group, or they are linked to each other to form a spiro ring (provided that when s is 0).

R⁵³ and R⁵⁴ are each independently a fluorine atom or a C₁₋₅ perfluoroalkyl group.

R⁵⁵ is a fluorine atom, a C₁₋₅ perfluoroalkyl group or a C₁₋₅ perfluoroalkoxy group. R⁵⁵ is preferably a fluorine atom in view of high polymerizability.

The perfluoroalkyl group and the perfluoroalkoxy group may be linear or branched and are preferably linear.

The content of the units based on the monomer having a cyclic ether structure is, to all units in the polymer F-2, preferably 30 mass % or more, more preferably 48 mass % or more, and preferably 70 mass % or less, more preferably 63 mass % or less.

Specific examples of the fluorinated monomer having a group convertible to an ion exchange group are the same as those of the fluorinated monomer having a group convertible to an ion exchange group for the polymer F-1.

The content of the units based on the fluorinated monomer having a group convertible to an ion exchange group is, to all units in the polymer F-2, preferably 20 mass % or more, more preferably 28 mass % or more, and preferably 60 mass % or less, more preferably 50 mass % or less.

The polymer F-2 may have units based on a fluorinated olefin. Specific examples of the fluorinated olefin are the same as those of the fluorinated olefin for the polymer F-1.

The content of the units based on the fluorinated olefin (particularly TFE) is, to all units in the polymer F-2, preferably 0 mass % or more, more preferably 1 mass % or more, and preferably 20 mass % or less, more preferably 10 mass % or less.

### (Content of Polymer F)

The content of the polymer F is, to the total mass of the liquid composition, with a view to more favorably agglomerating the polymer F, preferably 5 mass % or more, more preferably 14 mass % or more, and in view of more excellent solubility or dispersibility in the first solvent, preferably 30 mass % or less, more preferably 20 mass % or less.

### (Physical Property of Polymer F)

The TQ value of the polymer F is preferably 150° C. or higher, more preferably 170° C. or higher, further preferably 200° C. or higher, and is preferably 350° C. or lower, more preferably 340° C. or lower, further preferably 300° C. or lower.

The TQ value is a value relating to the molecular weight of the polymer, represents a temperature at which the volume flow rate becomes 100 mm³/see, and is obtained by the following method.

The TQ value of the polymer F is obtained in accordance with the method in Examples described later.

By converting the groups convertible to ion exchange groups in the polymer F to ion exchange groups by a known treatment such as a hydrolyzing treatment of conversion to an acid form, a fluorinated polymer having ion exchange groups (hereinafter also referred to as “polymer H”) is obtained.

The ion exchange capacity of the polymer H is preferably 0.8 meq/g dry resin or more, more preferably 0.9 meq/g dry resin or more, further preferably 1.0 meq/g dry resin or more, and is preferably 2.5 meq/g dry resin or less, more preferably 2.2 meq/g dry resin or less, further preferably 2.0 meq/g dry resin or less.

The ion exchange capacity of the polymer H is obtained in accordance with the method in Examples described later.

### (Method for Producing Polymer F)

As an example of the method for producing the polymer F, a method of copolymerizing the above-described monomers in a reactor in the presence of a polymerization initiator may be mentioned.

Specific examples of the copolymerization method include bulk polymerization, solution polymerization, suspension polymerization and emulsion polymerization.

In the case of solution polymerization, specific examples of the polymerization solvent include chlorofluorocarbons, hydrochlorofluorocarbons, hydrofluorocarbons and hydrofluoroethers.

Further, in a case where the polymer F is produced by solution polymerization, the polymerization solvent may be the first solvent (described later) contained in the liquid composition.

Specific examples of the polymerization initiator include diacyl peroxides (such as disuccinic peroxide, benzoyl peroxide, perfluoro-benzoyl peroxide, lauroyl peroxide and bis(pentafluoropropionyl) peroxide), azo compounds (such as 2,2′-azobis(2-amidinopropane) hydrochloride, 4,4′-azobis(4-cyanovalerianate), dimethyl 2,2′-azobisisobutyrate and azobisisobutyronitrile), peroxyesters (such as t-butyl peroxyisobutylate and t-butyl peroxypivalate), peroxydicarbonates (such as diisopropyl peroxydicarbonate and bis(2-ethylhexyl) peroxydicarbonate), hydroperoxides (such as diisopropylbenzene hydroperoxide and t-butyl hydroperoxide), and dialkyl peroxides (such as di-t-butyl peroxide and perfluoro-di-t-butyl peroxide).

The polymerization initiator may be used as a solution having it dissolved in a solvent (hereinafter also referred to as “initiator solution”).

The solvent in the initiator solution may be the first solvent (described later) contained in the liquid composition.

The amount of the polymerization initiator added is, per 100 parts by mass of the monomer component, preferably 0.0001 parts by mass or more, more preferably 0.001 parts by mass or more, and is preferably 3 parts by mass or less, more preferably 2 parts by mass or less.

The monomer and the polymerization initiator may be added continuously or sequentially to the reactor.

The amounts of the monomers added may properly be determined so that the contents of the respective monomer units in the polymer F will be within the above range.

The copolymerization temperature is preferably 20° C. or higher, more preferably 30° C. or higher, and is preferably 150° C. or lower, more preferably 130° C. or lower.

The polymerization pressure (gage pressure) is preferably 0.05 MPa [gage] or more, more preferably 0.5 MPa [gage] or more, and is preferably 2 MPa [gage] or less, more preferably 1.5 MPa [gage] or less.

### <First Solvent>

The first solvent is a solvent in which the polymer F is dissolved or dispersed (good solvent).

Specific examples of the first solvent include an organic solvent, an unreacted monomer used for polymerization of the polymer F, and an oligomer which forms at the time of production of the polymer F.

The first solvent may be used alone or in combination of two or more. In view of availability, cost, boiling point, separation and recovery efficiency, etc., preferred is an organic solvent or the unreacted monomer used of production of the polymer F.

The organic solvent is preferably a fluorinated solvent or a hydrocarbon solvent, in view of excellent solubility or dispersibility of the polymer F.

If the number of carbon atoms in the fluorinated solvent is too small, the boiling point tends to be low and recyclability and handling efficiency at room temperature of the solvent tend to be insufficient, and if it is too large, the boiling point tends to be high and recycle of the polymer and drying of the polymer after agglomeration and separation tend to be difficult. Thus, the number of carbon atoms in the fluorinated solvent is preferably 1 to 8, more preferably 2 to 7, further preferably 3 to 6.

If the normal boiling point of the fluorinated solvent is too low, recyclability and handling efficiency at room temperature tend to be insufficient, and if it is too high, recycle of the solvent and drying of the polymer after agglomeration and separation tend to be difficult. Thus, the normal boiling point is preferably 20 to 200° C., more preferably 34 to 140° C., further preferably 48 to 83° C.

Specific examples of the fluorinated solvent include hydrofluorocarbons such as CF₃(CF₂)₄CF₂H, CF₃(CF₂)₆CF₂H, HCF₂(CF₂)₂CF₂H, CF₃CF₂CHFCHFCF₃, CF₃CF(CF₃)CHFCHFCF₃, CF₃CH₂CF₂CH₃, and 1,1,2,2,3,3,4-heptafluorocyclopentane;
Hydrochlorofluorocarbons such as ClCF₂CF₂CHFCl (1,3-dichloro-1,1,2,2,3-pentafluoropropane), CF₃CF₂CHCl₂ and CH₃CCl₂F;
Hydrofluoroethers such as HCF₂CF₂OCH₂CF₃, n-C₃F₇OCH₃, n-C₃F₇OCHFCF₃, n-C₃F₇OCH₂CF₃, n-C₄F₉OCH₃, iso-C₄F₉OCH₃, n-C₄F₉OCH₂CH₃, n-C₄F₉OCH₂CF₃, CF₃OCF(CF₃)CF₂OCHs and n-C₃F₇OCF(CF₃)CF₂OCHFCF₃;
Chlorofluorocarbons such as CCl₃F, CCl₂F₂, CClF₂CClF₂ and Cl₂FCCClF₂;
Perfluoroketones such as (CF₃)₂CFC(O)CF(CF₃)₂ and CF₃CF₂CF₂C(O)CF(CF₃)₂;
Hydrochlorofluoroolefins such as CF₃CCl═CH₂, (Z)—CF₃CF═CHCl, (E)-CF₃CH═CHCl, (Z)—CF₃CH═CHCl, CF₃CCl═CHCl, (E)-CHF₂CF═CHCl, (Z)—CHF₂CF═CHCl and (Z)—CHF₂CF₂CF₂CF═CHCl; and
Chlorofluoroolefins such as CF₃CF═CCl₂ and CF₃CCl═CCl₂.

Specific examples of the hydrocarbon solvent include pentane, hexane, heptane, octane, hexadecane, isohexane, isooctane, isononane, isododecane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, tert-butylbenzene, methanol, ethanol and tert-butanol.

Specific examples of the unreacted monomer used for production of the polymer F include the compounds represented by the above formula (1).

Specific examples of the oligomer which forms at the time of production of the polymer F includes an oligomer formed by polymerization of the above fluorinated olefin and the compound represented by the above formula (1), and its molecular weight is usually several tens of thousands or less.

The degree of swelling of the polymer F in the first solvent is preferably 1 mass % or more, more preferably 3 mass % or more, further preferably 7 mass % or more, in that the liquid composition is excellent in dispersibility and solubility and in the after-described step 2, the polymer F can be more favorably agglomerated.

The degree of swelling of the polymer F in the first solvent is obtained in accordance with the following procedure.

Particles of the polymer F are heat-pressed to obtain a 100 μm thickness film. A 20 mm square sample was cut out from the film, and the sample dry mass (W1) is measured. The sample is dipped in 50 g of the first solvent at 25° C. in a sealed environment for 16 hours. The sample is taken off from the solvent and quickly wiped the solvent off, and the sample wet mass (W2) is measured. From the measured dry mass (W1) and the wet mass (W2), the degree of swelling is measured in accordance with the following formula:

$$Degree of swelling ( \% ) = ( W 2 - W 1 ) / W 1 \times 100$$

In view of excellent dispersibility or solubility of the first solvent, the first solvent preferably contains at least one member selected from the group consisting of the unreacted monomer used for production of the polymer F (preferably the compound represented by the formula (1)) and the organic solvent (preferably the fluorinated organic solvent).

The content of the first solvent is, to the total mass of the liquid composition, preferably 70 mass % or more, more preferably 75 mass % or more, further preferably 80 mass % or more, in view of more excellent solubility or dispersibility of the polymer F. It is preferably 95 mass % or less, more preferably 90 mass % or less, further preferably 85 mass % or less, in that excessive formation of the polymer into fine particles in step 2 is suppressed, favorable filtration property is obtained in step 3 and the amount of the solvent used at the time of agglomeration can be reduced.

The mass ratio of the content of the polymer F to the content of the first solvent (the content of the polymer F/the content of the first solvent) is preferably 0.050 or more, more preferably 0.054 or more, further preferably 0.060 or more, in that excessive formation of the polymer into fine particles in step 2 is suppressed, favorable filtration property will be obtained in step 3 and the amount of the solvent used at the time of agglomeration can be reduced. It is preferably 0.43 or less, more preferably 0.24 or less, further preferably 0.10 or less, in view of more excellent solubility or dispersibility of the polymer F.

### [Second Solvent]

The second solvent is an olefin having a fluorine atom and a chorine atom, and is a solvent used to agglomerate the polymer F in the liquid solvent to form particle of the polymer F (poor solvent).

### Specific Examples of the Second Solvent Include:

Hydrochlorofluorocarbons such as CF₃CCl═CH₂ (14° C.), (Z)—CF₃CF═CHCl (15° C.), (E)-CF₃CH═CHCl (18° C.), (Z)—CF₃CH═CHCl (39° C.), CF₃CCl═CHCl (54° C.), (E)-CHF₂CF═CHCl (47 to 48° C.), (Z)—CHF₂CF═CHCl (54° C.) and (Z)—CHF₂CF₂CF₂CF═CHCl (89° C.); and
Chlorofluorocarbons such as CF₃CF═CCl₂ (46° C.) and CF₃CCl═CCl₂ (88° C.). The values in a bracket of the above specific examples represent the normal boiling point (the boiling temperature under 1 atm). A mixture of (E)- and (Z)—CHF₂CF═CHCl (the content of (E)-CHF₂CF═CHCl is 10 mass % or less) has a boiling point of 54° C.

The second solvent may be used alone or in combination of two or more.

The number of carbon atoms in the olefin as the second solvent is preferably 2 to 8, more preferably 2 to 5, further preferably 3, in that more excellent effects of the present invention will be achieved and the polymer F will be more favorably agglomerated.

The normal boiling point of the olefin as the second solvent is preferably 14° C. or higher, more preferably 15° C. or higher, further preferably 39° C. or higher, in that sufficient handling efficiency at room temperature will be achieved. It is preferably 89° C. or lower, more preferably 88° C. or lower, further preferably 54° C. or lower, in that the polymer F will easily be separated from the polymerization medium.

### [Steps]

In this specification, the step of preparing the liquid composition containing the polymer F and the first solvent will also be referred to as “step 1”.

Further, the step of mixing the liquid composition with the second solvent to agglomerate the polymer F thereby to form particles containing the polymer F will also be referred to as “step 2”.

Now, the respective steps will be described in detail.

### <Step 1>

The method for preparing the liquid composition is not particularly limited, and the following method may, for example, be mentioned.

As an example of the method for preparing the liquid composition, a method may be mentioned in which by bulk polymerization method, a dispersion or solution having the polymer F dispersed or dissolved in an unreacted monomer used for production of the polymer F or an organic solvent is obtained, and the obtained dispersion or solution is used as the liquid composition. In this case, the unreacted monomer or the organic solvent corresponds to the first solvent.

In the dispersion or solution obtained by the bulk polymerization method, a component corresponding to the first solvent, such as the above described oligomer, may be contained in addition to the polymer F and the unreacted monomer.

As another example of the method for preparing the liquid composition, a method may be mentioned in which by solution polymerization method, a dispersion or solution having the polymer F dispersed or dissolved in a polymerization solvent is obtained, and the obtained dispersion or solution is used as the liquid composition. In this case, the polymerization solvent corresponds to the first solvent.

In the dispersion or solution obtained by the solution polymerization method, a component corresponding to the first solvent, such as the above described unreacted monomer or oligomer, may be contained in addition to the polymer F and the polymerization solvent.

### <Step 2>

In step 2, the liquid composition obtained in step 1 and the above second solvent are mixed to agglomerate the polymer F.

The temperature of the liquid composition immediately before mixed with the second solvent is preferably 20° C. or higher, more preferably 23° C. or higher, further preferably 25° C. or higher, in that excellent dispersibility or solubility of the liquid composition will be achieved, lump formulation of the polymer is suppressed in step 2, and particles containing the polymer F, having an appropriate particle size, can be produced. Further, it is preferably 70° C. or lower, more preferably 60° C. or lower, further preferably 50° C. or lower, in that an energy to heat the liquid composition can be reduced in step 1.

The temperature of the second solvent immediately before mixed with the liquid composition is preferably −15° C. or higher, more preferably −10° C. or higher, further preferably −5° C. or higher, in that an energy to cool the second solvent can be reduced in step 2. Further it is preferably 30° C. or lower, more preferably 28° C. or lower, further preferably 25° C. or lower, in that the polymer F is likely to agglomerate and excessive formation of the polymer into fine particles is suppressed in step 2.

It is preferred to conduct stirring treatment before the liquid composition and the second solvent are mixed.

The stirring conditions may be known conditions. For example, the optimum number of revolutions for stirring varies depending upon the shape of agitating blade, the scale of the treatment chamber, etc., and is preferably 1 to 500 rpm.

The stirring treatment may be conducted under normal pressure or under an elevated pressure in a pressure container.

The stirring time is preferably 15 minutes to 16 hours, more preferably 30 minutes to 8 hours. The stirring time tends to be shorter when the temperature of the second solvent is higher.

The stirring means is not particularly limited and a known stirring apparatus may be used.

In step 2, when the liquid composition and the second solvent are mixed, the mass ratio of the mass of the second solvent to the mass of the first solvent in the liquid composition (the mass of the second solvent/the mass of the first solvent in the liquid composition) is preferably 1.0 or more, more preferably 1.5 or more, further preferably 2.0 or more, in that the polymer F can more favorably be agglomerated.

The above mass ratio (the mass of the second solvent/the mass of the first solvent in the liquid composition) is preferably 8.0 or less, more preferably 6.0 or less, further preferably 3.5 or less, in that the particles of the polymer F can be easily adjusted to have an appropriate particle size.

In step 2, when the liquid composition and the second solvent are mixed, the second solvent may be added to the liquid composition all at once or in divided portions.

In a case where the second solvent is added in divided portions, the second solvent that is added first may be used to dilute the liquid composition.

In a case where the second solvent is added in divided portions, the second solvent in different additions may be the same or different.

### <Other Step>

The method for producing the fluorinated polymer of the present invention may further have a step other than the above (hereinafter also referred to as “other step”).

Specific examples of the other step include step 3 of separating and recovering the particles containing the polymer F from the liquid that contains the particles containing the polymer F after step 2.

The separation method in step 3 may be a known filtration method such as pressure filtration, vacuum filtration, atmospheric filtration or centrifugal filtration.

The step 3 may have washing treatment of washing the recovered particles containing the polymer F with a washing solvent (preferably the above second solvent).

The washing treatment may be conducted once or several times.

The step 3 may have drying treatment of drying the recovered particles containing the polymer F. In a case where washing treatment is conducted in step 3, it is preferred to conduct the drying treatment after the washing step.

The drying method may be a known drying method such as hot air drying, vacuum drying, suction drying, infrared drying, air (nitrogen) blow drying.

The drying temperature in the drying treatment is preferably −15° C. or higher, more preferably −10° C. or higher, and is preferably 80° C. or lower, more preferably 70° C. or lower.

The drying time in the drying treatment is preferably 30 minutes or longer, more preferably 60 minutes or longer. It is also preferably 24 hours or shorter, more preferably 21 hours or shorter.

### [Particles Containing Polymer F]

In the particles containing the polymer F obtained by the present production method, the content of the polymer F is, to the total mass of the particles containing the polymer F, preferably 5 mass % or more, more preferably 15 mass %, further preferably 24 mass % or more, and is preferably 52 mass % or less, more preferably 46 mass % or less, further preferably 40 mass % or less.

The average particle size of the particles containing the polymer F obtained by the present production method is preferably 38 μm or more, more preferably 500 μm or more, further preferably 1000 μm or more, in that excessive formation of the polymer particles into fine particles is suppressed in step 2 and favorable filtration property is obtained in step 3. Further, it is preferably 10000 μm or less, more preferably 5000 μm or less, further preferably 2000 μm or less, in that components other than the polymer F in the particles are likely to be removed.

The average particle size of the particles containing the polymer F is a value calculated from the particle size distribution obtained by mechanical sieving using a test sieve of stainless steel (JIS-Z8801).

### EXAMPLES

Now, the present invention will be described in further detail with reference to Examples. Ex. 1 to 4 are Examples of the present invention, and Ex. 5 to 6 are Comparative Examples. However, it should be understood that the present invention is by no means restricted to such specific Ex.

### [Measurement of Mass Reduction Rate]

The particles containing the polymer F obtained immediately after the washing treatment in each Ex. were weight to measure the mass W1.

Then, the particles containing the polymer F obtained immediately after the washing treatment in each Ex. were air-dried in a forced hot air circulating/ventilation oven (manufactured by ESPEC CORP., Desk-top Type High-Temp. Chamber STH-120) at 50° C. for 2 hours. The mass W2 (0.5) of the particles containing the polymer F 0.5 hours after air-drying under heating, the mass W2 (1) of the particles containing the polymer F one hour after air-drying under heating, and the mass W2 (2) of the particles containing the polymer F two hours after air-drying under heating, were measured.

Based on the measured mass W1 and mass W2, in accordance with the following formula (W), the mass reduction rate of the particles containing the polymer F at each time point of air-drying under heating was obtained.

The results are represented by an index taking the mass reduction rate by the formula (W) calculated based on the mass W2 (0.5) in Ex. 5 as 100. A lower index means less impurities in the particles containing the polymer F. The results are shown in Table 2 described later.

$$Mass reduction rate ( \% ) = 100 \times ( W 1 - W 2 ) / W 1$$

$$In the formula , W 2 represents W 2 ( 0.5 ) , W 2 ( 1 ) , or W 2 ( 2 ) .$$

### [Ion Exchange Capacity]

The particles containing the polymer F after air-dried in each Ex. were vacuum-dried at 240° C. for 16 hours. Into a polycarbonate container, the polymer F after dried was weighed and dipped in a 0.7N NaOH solution (solvent: H₂O/CH₃OH=10/90 (mass ratio)) at 60° C. for 72 hours or longer to completely convert-SO₂F groups in the dried polymer F to Na salt form. The NaOH solution in which the dried polymer F had been dipped was subjected to back-titration with 0.1 mol/L HCl using phenolphthalein as an indicator to obtain the amount of NaOH in the solution, thereby to calculate the ion exchange capacity (meq/g dry resin). The results are shown in Table 2 described later.

In Table 2, “meq/g” means the “meq/g/dry resin” as the unit of the ion exchange capacity.

In a case where there were three or more types of monomers, the ion exchange capacity was calculated from the composition obtained by ¹⁹F-NMR.

### [TQ Value]

The particles containing the polymer after air-dried in each Ex. were vacuum-dried at 240° C. for 16 hours. The vacuum-dried particles containing the polymer were melt-extruded using a flow tester (manufactured by Shimadzu Corporation, CFT-500D) equipped with a nozzle having a length of 1 mm and an inner diameter of 1 mm while the temperature was changed under an extrusion pressure of 2.94 MPa (gage pressure). The TQ value, which is a temperature at which the polymer extrusion amount becomes 100 mm³/sec, was calculated. The results are shown in Table 2 described later.

### [Monomer]

TFE: tetrafluoroethylene

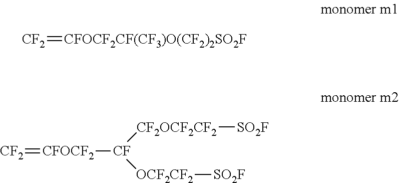

monomer m3: perfluoro (2,2-dimethyl-1,3-dioxole)

### [Radical Polymerization Initiator]

V-601: dimethyl 2,2′-azobis(2-methylpropionate)·
AIBN: 2,2′-azobis(isobutyronitrile)

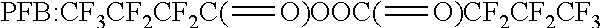

### [Solvent]

HCFO-1233 yd (E)/(Z): a mixture of (E)-CHF₂CF═CHCl and (Z)—CHF₂CF═CHCl (AMOLEA (registered trademark) AS-300 (manufacture by AGC Inc.), normal boiling point 54° C.
HFE-347pc-f: HCF₂CF₂OCH₂CF₃, ASAHIKLIN AE-3000 (manufacture by AGC Inc.), normal boiling point 56° C.
HFC-52-13p: CF₃(CF₂)₄CF₂H, ASAHIKLIN AC-2000 (manufacture by AGC Inc.), normal boiling point 71.8° C.

### Ex. 1

### <Step 1>

186 g of the monomer m1 was charged into a 230 mL stainless steel reactor, and sufficiently freeze-pump-thaw degassed with liquid nitrogen. The monomer was stirred at 300 rpm and heated to 55° C., 0.17 MPa of nitrogen gas was introduced, TFE was introduced, and the total pressure was adjusted to be 0.85 MPaG (gage pressure, the same applies hereinafter).

3.82 g of an initiator solution having V-601 as the radical polymerization initiator dissolved at a concentration of 1.43 mass % in the monomer m1, was injected to the reactor to initiate polymerization. While the initial pressure was maintained, TFE was continuously added.

At a point when the amount of the continuously added TFE reached 15.4 g, the reactor was cooled to 10° C. and purged of the unreacted TFE to obtain liquid composition 1, which is a solution having polymer F1 dissolved in the unreacted monomer m1.

### <Step 2>

100 g of the liquid composition 1 was diluted with 61.0 g of HCFO-1233 yd (E)/(Z). The diluted liquid composition was kept at 50° C., which was added to 193 g of HCFO-1233 yd (E)/(Z) at 25° C., followed by stirring to agglomerate the polymer F1, thereby to form particles containing the polymer F1.

After stirring, the liquid that contained the particles containing the polymer F1 was subjected to filtration through a filter paper. To the separated and recovered particles containing the polymer F1, 202 g of HCFO-1233 yd (E)/(Z) at 25° C. was added, followed by stirring and by filtration, for washing. The washing was conducted repeatedly three times in total to obtain 42.6 g of particles containing the polymer F1.

The particles containing the polymer F1 recovered were air-dried in a hot air-circulating oven at 50° C. for 2 hours to obtain 25.5 g of particles containing the polymer F1.

Using the air-dried particles containing the polymer F1, the ion exchange capacity and the TQ value were measured in accordance with the above method.

### Ex. 2

### <Step 1>

162 g of the monomer m1 was charged into a 230 mL stainless steel reactor, and sufficiently freeze-pump-thaw degassed with liquid nitrogen. The monomer was stirred at 300 rpm and heated to 60° C., and TFE was introduced at 60° C. until the pressure reached 1.30 MPaG.

0.86 g of an initiator solution having AIBN as the radical polymerization initiator dissolved at a concentration of 4.74 mass % in HCFO-1233 yd (E)/(Z), was injected to the reactor to initiate polymerization. While the initial pressure was maintained, TFE was continuously added.

At a point when the amount of the continuously added TFE reached 8.1 g, the reactor was cooled to 10° C. and purged of the unreacted TFE to obtain liquid composition 2, which is a solution having polymer F2 dissolved in the unreacted monomer m1 and HCFO-1233 yd (E)/(Z).

### <Step 2>

167 g of the liquid composition 2 was kept at 25° C., which was added to 451 g of HCFO-1233 yd (E)/(Z) at 25° C., followed by stirring to agglomerate the polymer F2, thereby to form particles containing the polymer F2.

After stirring, the liquid that contained the particles containing the polymer F2 was subjected to filtration through a filter paper. To the separated and recovered particles containing the polymer F2, 150 g of HCFO-1233 yd (E)/(Z) at 25° C. was added, followed by stirring and by filtration, for washing. The washing was conducted repeatedly three times in total to obtain 26.6 g of particles containing the polymer F2.

The particles containing the polymer F2 recovered were air-dried in a hot air-circulating oven at 50° C. for 2 hours to obtain 17.4 g of particles containing the polymer F2.

Using the air-dried particles containing the polymer F2, the ion exchange capacity and the TQ value were measured in accordance with the above method.

### Ex. 3

### <Step 1>

162 g of the monomer m1 was charged into a 230 mL stainless steel reactor, and sufficiently freeze-pump-thaw degassed with liquid nitrogen. The monomer was stirred at 300 rpm and heated to 50° C., and TFE was introduced at 50° C. until the pressure reached 1.25 MPaG.

1.25 g of an initiator solution having V-601 as the radical polymerization initiator dissolved at a concentration of 3.34 mass % in HCFO-1233 yd (E)/(Z), was injected to the reactor to initiate polymerization. While the initial pressure was maintained, TFE was continuously added.

At a point when the amount of the continuously added TFE reached 7.1 g, the reactor was cooled to 10° C. and purged of the unreacted TFE to obtain liquid composition 3, which is a solution having polymer F3 dissolved in the unreacted monomer m1 and HCFO-1233 yd (E)/(Z).

### <Step 2>

163 g of the liquid composition 3 was kept at 25° C., which was added to 525 g of HCFO-1233 yd (E)/(Z) at 25° C., followed by stirring to agglomerate the polymer F3, thereby to form particles containing the polymer F3.

After stirring, the liquid that contained the particles containing the polymer F3 was subjected to filtration through a filter paper. To the separated and recovered particles containing the polymer F3, 150 g of HCFO-1233 yd (E)/(Z) at 25° C. was added, followed by stirring and by filtration, for washing. The washing was conducted repeatedly three times in total to obtain 18.8 g of particles containing the polymer F3.

The particles containing the polymer F3 recovered were air-dried in a hot air-circulating oven at 50° C. for 2 hours to obtain 13.8 g of particles containing the polymer F3.

Using the air-dried particles containing the polymer F3, the ion exchange capacity and the TQ value were measured in accordance with the above method.

### Ex. 4

### <Step 1>

108 g pf the monomer m2, 29.0 g of the monomer m3 and 1.22 g of AC-2000 were charged into a 230 mL stainless steel reactor, 1.05 of a solution having PFB as the radical polymerization initiator dissolved at a concentration of 3.0 mass % in AC-2000 was added, and freeze-pump-thaw freezing with liquid nitrogen was sufficiently conducted.

Then, 4.15 g of TFE was charged, stirred at 100 rpm and heated to 24° C. to initiate polymerization. The reaction was continued for 8 hours while the internal temperature was maintained at 24° C., and then the reactor was cooled and purged of the unreacted TFE. The monomer m3 remaining was distilled off at 24° C. under reduced pressure for 3 hours to obtain liquid composition 4, which is a solution having polymer F4 dissolved in the unreacted monomer m2 and AC-2000.

### <Step 2>

53.5 g of the liquid composition 4 was diluted with 93.6 g of HCFO-1233 yd (E)/(Z). The diluted liquid composition was kept at 25° C., which was added to 208 g of HCFO-1233 yd (E)/(Z) at −6.3° C., followed by stirring to agglomerate the polymer F4, thereby to form particles containing the polymer F4.

After stirring, the liquid that contained the particles containing the polymer F4 was subjected to filtration through a filter paper. To the separated and recovered particles containing the polymer F4, 165 g of HCFO-1233 yd (E)/(Z) at 25° C. was added, followed by stirring and by filtration, for washing. The washing was conducted repeatedly three times in total to obtain 26.3 g of particles containing the polymer F4.

The particles containing the polymer F4 recovered were air-dried in a hot air-circulating oven at 50° C. for 2 hours to obtain 13.3 g of particles containing the polymer F4.

Using the air-dried particles containing the polymer F4, the ion exchange capacity and the TQ value were measured in accordance with the above method.

### Ex. 5

### <Step 1>

189 g of the monomer m1 was charged into a 230 mL stainless steel reactor, and sufficiently freeze-pump-thaw degassed with liquid nitrogen. The monomer was stirred at 300 rpm and heated to 55° C., 0.17 MPa of nitrogen gas was introduced, TFE was introduced, and the total pressure was adjusted to be 0.85 MPaG.

3.82 g of an initiator solution having V-601 as the radical polymerization initiator dissolved at a concentration of 1.43 mass % in HFC-52-13p, was injected to the reactor to initiate polymerization. While the initial pressure was maintained, TFE was continuously added.

At a point when the amount of the continuously added TFE reached 15.4 g, the reactor was cooled to 10° C. and purged of the unreacted TFE to obtain liquid composition 5, which is a solution having polymer F5 dissolved in the unreacted monomer m1 and HFC-52-13p.

### <Step 2>

100 g of the liquid composition 5 was diluted with 60.4 g of HFC-52-13p. The diluted liquid composition was kept at 25° C., which was added to 466 g of HFE-347pc-f at −30° C., followed by stirring to agglomerate the polymer F5, thereby to form particles containing the polymer F5.

After stirring, the liquid that contained the particles containing the polymer F5 was subjected to filtration through a filter paper. To the separated and recovered particles of the polymer, 201 g of HFE-347pc-f at 25° C. was added, followed by stirring and by filtration, for washing. The washing was conducted repeatedly three times in total to obtain 63.9 g of particles containing the polymer F5.

The particles containing the polymer F5 recovered were air-dried in a hot air-circulating oven at 50° C. for 2 hours to obtain 26.1 g of particles containing the polymer F5.

Using the air-dried particles containing the polymer F5, the ion exchange capacity and the TQ value were measured in accordance with the above method.

### Ex. 6

### <Step 1>

189 g of the monomer m1 was charged into a 230 mL stainless steel reactor, and sufficiently freeze-pump-thaw degassed with liquid nitrogen. The monomer was stirred at 300 rpm and heated to 55° C., 0.14 MPa of nitrogen gas was introduced, TFE was introduced, and the total pressure was adjusted to be 0.82 MPaG.

3.87 g of an initiator solution having V-601 as the radical polymerization initiator dissolved at a concentration of 1.41 mass % in HFE-347pc-f, was injected to the reactor to initiate polymerization. While the initial pressure was maintained, TFE was continuously added. At a point when the amount of the continuously added TFE reached 15.4 g, the reactor was cooled to 10° C. and purged of the unreacted TFE to obtain liquid composition 6, which is a solution having polymer F6 dissolved in the unreacted monomer m1 and HFE-347pc-f.

### <Step 2>

101 g of the liquid composition 6 was diluted with 62.5 g of HFE-347pc-f. The diluted liquid composition was kept at 50° C., which was added to 194 g of HFE-347pc-f at 25° C., followed by stirring to agglomerate the polymer F6, thereby to form particles containing the polymer F6.

After stirring, the liquid that contained the particles containing the polymer F6 was subjected to filtration through a filter paper. To the separated and recovered particles containing the polymer, 199 g of HFE-347pc-f at 25° C. was added, followed by stirring and by filtration, for washing. The washing was conducted repeatedly three times in total to obtain 56.0 g of particles containing the polymer F6.

The particles containing the polymer F6 recovered were air-dried in a hot air-circulating oven at 50° C. for 2 hours to obtain 26.1 g of particles containing the polymer F6.

Using the air-dried particles containing the polymer F6, the ion exchange capacity and the TQ value were measured in accordance with the above method.

The following Table 1 summarizes the conditions in step 1 in each Ex., and Table 2 summarizes the conditions, physical properties and evaluation results in step 2 in each Ex.

TABLE 1

| Table 1 | | | | Ex. 1 | Ex. 2 | Ex. 3 | Ex. 4 | Ex. 5 | Ex. 6 |
|---|---|---|---|---|---|---|---|---|---|
| Step 1 | Capacity of reactor | | mL | 230 | 230 | 230 | 230 | 230 | 230 |
| | Monomer | m1 | g | 189 | 162 | 162 | 0 | 189 | 189 |
| | | m2 | g | 0 | 0 | 0 | 108 | 0 | 0 |
| | | m3 | g | 0 | 0 | 0 | 29.0 | 0 | 0 |
| | | TFE | g | — | — | — | 4.15 | — | — |
| | Radial | V-601 | mg | 54.5 | 0 | 41.9 | 0 | 54.5 | 54.5 |
| | polymerization | AIBN | mg | 0 | 40.8 | 0 | 0 | 0 | 0 |
| | initiator | PFB | mg | 0 | 0 | 0 | 31.4 | 0 | 0 |
| | First solvent | Unreacted | g | 164 | 154 | 156 | 0 | 164 | 164 |
| | | monomer m1 | | | | | | | |
| | | Unreacted | g | 0 | 0 | 0 | 94.9 | 0 | 0 |
| | | monomer m2 | | | | | | | |
| | | AS-300 | g | 0 | 0.82 | 1.21 | 0 | 0 | 0 |
| | | AC-2000 | g | 0 | 0 | 0 | 2.24 | 3.77 | 0 |
| | | AE-3000 | g | 0 | 0 | 0 | 0 | 0 | 3.82 |

| | | | | | | | |
|---|---|---|---|---|---|---|---|
| Concentration of radical polymerization | mass % | 1.43 | 4.74 | 3.34 | 3.00 | 1.43 | 1.41 |
| initiator in initiator solution | | | | | | | |
| Amount of initiator solution added | g | 3.82 | 0.86 | 1.25 | 1.05 | 3.82 | 3.87 |
| Polymerization temperature | ° C. | 55 | 60 | 50 | 24 | 55 | 55 |
| Nitrogen gas pressure | MPa | 0.17 | 0 | 0 | 0 | 0.17 | 0.14 |
| Total pressure after TFE introduction | MPaG | 0.85 | 1.30 | 1.25 | — | 0.85 | 0.82 |
| Number of revolutions for stirring | rpm | 300 | 300 | 300 | 100 | 300 | 300 |
| Amount of TFE introduced | g | 15.4 | 8.1 | 7.1 | — | 15.4 | 15.4 |

| | | | | | | |
|---|---|---|---|---|---|---|
| Obtained polymer F | F1 | F2 | F3 | F4 | F5 | F6 |
| Obtained liquid composition | 1 | 2 | 3 | 4 | 5 | 6 |
| Mass of polymer F/Mass of first solvent | 0.25 | 0.11 | 0.09 | 0.34 | 0.24 | 0.24 |

TABLE 2

| Table 2 | | | | Ex. 1 | Ex. 2 | Ex. 3 | Ex. 4 | Ex. 5 | Ex. 6 |
|---|---|---|---|---|---|---|---|---|---|
| Step 2 | Amount of diluted liquid composition | | g | 161 | 167 | 163 | 147 | 161 | 163 |
| | Second solvent | AS-300 | g | 61.0 | 0 | 0 | 93.6 | 0 | 0 |
| | (for dilution) | AC-2000 | g | 0 | 0 | 0 | 0 | 60.4 | 0 |
| | | AE-3000 | g | 0 | 0 | 0 | 0 | 0 | 62.5 |
| | Temperature of liquid composition | | ° C. | 50 | 25 | 25 | 25 | 25 | 50 |
| | Second solvent | AS-300 | g | 193 | 451 | 525 | 208 | 0 | 0 |
| | (for agglomeration) | AC-2000 | g | 0 | 0 | 0 | 0 | 0 | 0 |
| | | AE-3000 | g | 0 | 0 | 0 | 0 | 466 | 194 |
| | Temperature of second solvent | | ° C. | 25 | 25 | 25 | −6.3 | −30 | 25 |
| | Washing solvent | AS-300 | g | 202 | 150 | 150 | 165 | 0 | 0 |
| | | AC-2000 | g | 0 | 0 | 0 | 0 | 0 | 0 |
| | | AE-3000 | g | 0 | 0 | 0 | 0 | 201 | 199 |

| | Temperature of washing solvent | ° C. | 25 | 25 | 25 | 25 | 25 | 25 |
|---|---|---|---|---|---|---|---|---|
| | Number of washing | time | 3 | 3 | 3 | 3 | 3 | 3 |
| | Yield of particles containing polymer F | g | 42.6 | 26.6 | 18.8 | 26.3 | 63.9 | 56.0 |
| | Air-drying temperature | ° C. | 50 | 50 | 50 | 50 | 50 | 50 |
| | Air-drying time | hour | 2 | 2 | 2 | 2 | 2 | 2 |
| | Yield of air-dried particles containing | g | 25.5 | 17.4 | 13.8 | 13.3 | 26.1 | 26.1 |
| | polymer F | | | | | | | |
| | Mass of second solvent/mass of first solvent in | | 3.17 | 2.99 | 3.48 | 7.54 | 6.41 | 3.10 |
| | liquid composition | | | | | | | |
| Evaluation | Mass reduction rate (index) | 0.5 hours | 74 | 55 | 49 | 90 | 100 | 93 |
| results | | 1 hour | 74 | 62 | 49 | 92 | 107 | 97 |
| | | 1.5 hours | 74 | 64 | 49 | 92 | 110 | 99 |
| Physical | Ion exchange capacity | meq/g | 1.42 | 1.09 | 0.99 | 1.27 | 1.42 | 1.41 |
| properties | TQ value | ° C. | 220 | 218 | 229 | 278 | 218 | 226 |

As shown in Table 2, it was confirmed that according to the method for producing particles containing the fluorinated polymer of the present invention, particles containing the fluorinated polymer with a low content of impurities can be produced (Ex. 1 to 4).

This application is a continuation of PCT Application No. PCT/JP2024/030617, filed on Aug. 28, 2024, which is based upon and claims the benefit of priority from Japanese Patent Application No. 2023-143764 filed on Sep. 5, 2023. The contents of those applications are incorporated herein by reference in their entireties.

What is claimed is:

1. A method for producing particles containing a fluorinated polymer having groups convertible to ion exchange groups,
which comprises preparing a liquid composition containing the fluorinated polymer and a first solvent, and
mixing the liquid composition with a second solvent that is an olefin having a fluorine atom and a chlorine atom, to agglomerate the fluorinated polymer thereby to form particles containing the fluorinated polymer.

2. The method for producing particles containing a fluorinated polymer according to claim 1, wherein the olefin has three carbon atoms.

3. The method for producing particles containing a fluorinated polymer according to claim 1, wherein the olefin has a normal boiling point of 14 to 89° C.

4. The method for producing particles containing a fluorinated polymer according to claim 1, wherein the fluorinated polymer has units based on tetrafluoroethylene and units based on a compound represented by the formula (1): 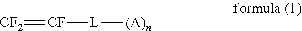
in the formula (1), L is a (n+1)-valent perfluorohydrocarbon group which may have an etheric oxygen atom, A is a group convertible to a sulfonic acid functional group, and n is 1 or 2.

5. The method for producing particles containing a fluorinated polymer according to claim 4, wherein the first solvent contains at least one member selected from the group consisting of the compound represented by the formula (1) and an organic solvent.

6. The method for producing particles containing a fluorinated polymer according to claim 1, wherein a mass ratio of a content of the fluorinated polymer to a content of the first solvent in the liquid composition is 0.050 to 0.43.

7. The method for producing particles containing a fluorinated polymer according to claim 1, wherein when the liquid composition and the second solvent are mixed, a mass ratio of the mass of the second solvent to a mass of the first solvent in the liquid composition is 1.0 to 8.0.

8. The method for producing particles containing a fluorinated polymer according to claim 1, wherein a content of the first solvent is 70 mass % or more and 95 mass % or less to a total mass of the liquid composition.

9. The method for producing particles containing a fluorinated polymer according to claim 1, wherein the particles have an average particle size of 38 μm or more and 10000 μm or less.

10. The method for producing particles containing a fluorinated polymer according to claim 1, wherein the mixing is conducted by using the liquid composition having a temperature of 20° C. or higher and 60° C. or lower, and the second solvent having a temperature of −15° C. or higher and 30° C. or lower.
